(19) United States
(12) Patent Application Publication
(10) Pub. No.: US 2016/0237982 A1
(43) Pub. Date: Aug. 18, 2016

(54) WATER TURBINE DRIVE SYSTEM

(71) Applicant: REAL NEWENERGY, LLC, San Anselmo, CA (US)

(72) Inventors: Joris BENNINGA, Arnhem (NL); Matthew ROSS, San Francisco, CA (US); Jayden HARMAN, Princeville, HI (US)

(21) Appl. No.: 14/916,419

(22) PCT Filed: Sep. 4, 2014
(86) PCT No.: PCT/US14/54102

§ 371 Date: Mar. 3, 2016

Related U.S. Application Data
(60) Provisional application No. 61/873,917, filed on Sep. 5, 2013.

(51) Int. Cl. F03B 15/04; F03B 13/26; F03B 13/10; F03B 13/22

(52) U.S. Cl. CPC F03B 15/04; F03B 13/22; F03B 13/264; F03B 13/10

(57) ABSTRACT

A water turbine drive system is described for generating rotational power from a flowing water stream. The water turbine drive system comprises a rotating machine driven by a water turbine disposed remote from the machine, where the machine and turbine are connected together by a tether member adapted to be rotated by the turbine and transmit the rotation and thereby drive the machine. The tether member permits positional movement of the turbine relative to the machine such that the rotational axis of the turbine need not be co-aligned with the rotational axis of a driven rotating member of the machine.

### CROSS-REFERENCE TO RELATED APPLICATIONS

This application claims a benefit of, and priority to under 35 U.S.C. §119(e), U.S. Provisional Application Ser. No. 61/873,917, filed on Sep. 5, 2013, which is incorporated herein by reference in its entirety.

### BACKGROUND

The disclosure generally relates to the generation of energy from river flows, tidal flows, ocean currents and man-made water streams.

Marine and hydrokinetic devices have a variety of technology types and deployment schemes. Most devices, especially horizontal axis marine hydrokinetic turbines, require depths in excess of 6 meters and flow speeds greater than 2 meters per second (m/s). There are a limited number of viable sites as a result of these requirements.

Another issue impacting the growth of the marine hydrokinetic industry is debris handling. Fast flowing rivers will often carry fine and coarse sediment and larger items such as branches, trees and trash from man-made activities. Debris-strikes from the aforementioned items and others can cause damage to the turbines and energy-generating devices. The damage can reduce efficiency and even cause reason for project termination. Such damaging effects (among others) are entanglement, clogging, and direct strikes leading to dented or broken components.

There is a need for devices that can generate energy from rivers, tides, ocean currents and man-made water streams which do not require a dam or significant alterations to the flow of the body of water, be deployed in relatively shallow water and be less vulnerable to damage or destruction by floating debris.

### SUMMARY

According to one embodiment, a water turbine drive system for generating rotational power from a flowing water stream. The water turbine drive system comprises a rotating machine driven by a water turbine disposed remote from the machine, where the machine and turbine are connected together by a tether member adapted to be rotated by the turbine and transmit the rotation and thereby drive the machine The tether member permits positional movement of the turbine relative to the machine such that the rotational axis of the turbine need not be co-aligned with the rotational axis of a driven rotating member of the machine.

According to one embodiment, the turbine comprises a rotor which is configured to cause the turbine to position itself in the region of greatest water flow as a result of the water flow.

According to one embodiment, the tether member and rotor in combination permit the turbine freedom to establish vertical equilibrium within the water column to further allow the turbine to position itself in the region of greatest water flow as a result of the water flow. This feature may be accomplished by permitting the machine to pivot within the vertical plane while preventing the turbine from coming into contact with bottom of the body of flowing water.

According to one embodiment, the rotor is configured with an active surface which defines an arcuate fluid pathway for fluid flow about the central axis about which the rotor is able to rotate, wherein the surface has the configuration of a logarithmic curve substantially conforming to the Golden Section to thereby enable the rotor to be caused to move into the region of greatest water flow.

According to one embodiment, the tether member and rotor in combination improve the transmission of rotational movement from the turbine to the power take off device by reducing the angle between the water surface and the power take off device. This feature may be accomplished by permitting the tether to connect the turbine to the machine through the floating platform or existing structure at a height just above the water surface.

According to one embodiment, the tether member is flexible.

According to one embodiment, the material of the tether member and the material and configuration of the turbine are selected to ensure stable position of the rotor with the water flow stream.

According to one embodiment, the turbine is caused to rotate by a water stream of a river.

According to one embodiment, the turbine is caused to rotate by tidal water flow.

According to one embodiment, the turbine is caused to rotate by ocean currents.

According to one embodiment, the turbine is caused to rotate by water flow resulting from man-made canals, flumes or effluent systems.

According to one embodiment, the machine is supported above the surface of the water by a floatation device.

According to one embodiment, the machine is supported above the surface of the water on land or on a support platform.

According to one embodiment, the machine is an electrical generator.

According to one embodiment, the machine is a device which can convert rotational energy into useable power in the form of electrical energy.

According to one embodiment, the machine is a device which can convert rotational energy into useable power in the form of mechanical work.

According to one embodiment, a tether member is operatively connected to a water-driven turbine with a rotating machine to allow the tether member to transmit torque generated by the turbine to the machine to cause rotation of a rotating member of the machine, wherein the tether member is configured to permit angular displacement of the turbine rotational axis relative to the rotating member rotational axis during use.

### BRIEF DESCRIPTION OF THE DRAWINGS

FIG. 1 is a top view of the above-the-water deployment configuration consisting of a floating platform according to a first embodiment.

FIG. 2 is a top view of the above-the-water deployment configuration consisting of a permanent structure according to a second embodiment.

FIG. 3 is a water level view of the deployment configuration consisting of a floating platform according to the first embodiment.

### DETAILED DESCRIPTION

A water turbine drive system is described that is directed for use with an above-the-water electrical generator. In the water turbine drive system, a turbine (10) is connected to the generator (17) via a tether member in the form of a flexible tethering cable (11). The turbine (10) is the component that harnesses the energy from the flowing body of water and rotates at a rate proportional to the flow speed. This rotation causes the flexible tethering cable (11) to rotate and drive the generator, which in this case is an electrical generator (17).

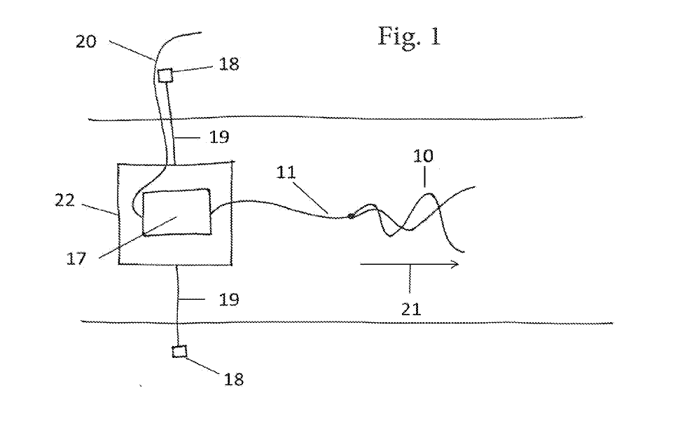

As shown in FIG. 1 the generator (17) is located above the water on a floatation means comprising a floating platform (22) that in this case is anchored to the shore on either side of the river or tidal pass by anchoring stakes (18) and chains (19). The turbine (10) is connected to the generator (17) via a flexible tethering cable (11) which translates the rotational energy captured by the turbine(10) into electricity by driving the generator (17) to which it is attached. The generator (17) is located upstream of the turbine (10) which is depicted by the arrow indicating the direction of water flow (21). It is important to note that the generator (17) is proposed to be a low speed electrical generator of any kind but may also be any device which can convert rotational energy into useable power such as a pump. The cabling (20) may run along the anchoring chains (19) or in another manner more advantageous for the deployment location. This cabling can deliver the energy generated by the generator (17) to any on-grid or off-grid electricity system.

Alternatively, if the water turbine drive system includes a device which can covert rotational energy into useable power (e.g., electrical energy or mechanical work), the device may be located on the floating platform, thereby reducing or eliminating the need for electric cabling on the shore.

The generator may also be supported to permit slight positional adjustments in the vertical axis but restricts most lateral movements (with respect to the water flow (21)), allowing the turbine (10) to establish its vertical equilibrium about the axis as water flow conditions change.

The properties of the turbine (10), the flexibility added by the tethering cable (11) and the floating platform (22) are configured to work together so that the turbine (10) establishes itself, stably, in the area of greatest flow, thereby maximizing energy generating potential. Generally, a turbine is an object that rotates as a result of flowing water contacting the turbine. The turbine includes a rotor having a specific shape that allows for the turbine to exhibit the features described below. In one embodiment, the rotor is configured according to the U.S. Pat. No. 5,934,877 (the '877 patent), which is incorporated by reference herein in its entirety. This rotor causes the turbine to move to the region of maximum water flow in the water stream.

Within the '877 patent, the meaning of the terms logarithmic scaled shape and Golden section are to be understood as used and intended in that disclosure. In particular, in one embodiment a rotor is selected which is configured with an active or operative surface which defines an arcuate fluid pathway for fluid flow about the central axis of the rotor about which the rotor is able to rotate, wherein the surface has the configuration of a logarithmic curve substantially conforming to the Golden Section to thereby allow the turbine to be caused to move into the region of greatest water flow. In addition, use of such a rotor has been found to reduce any tendency for instability such as the turbine moving about in a circle around an optimum point.

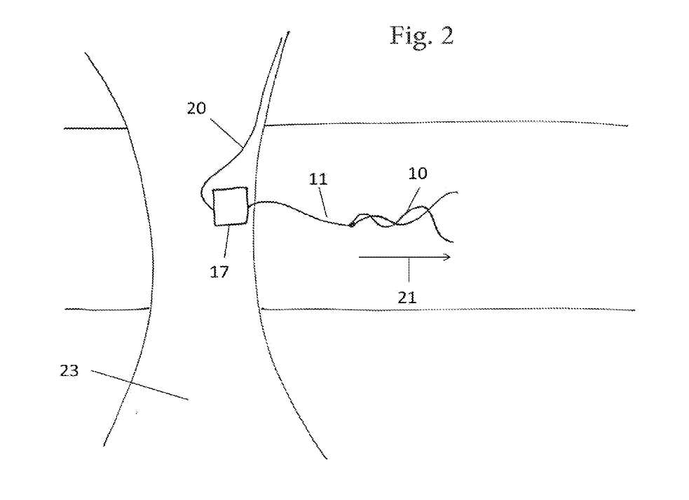

The embodiment as shown in FIG. 2 contains all the same components, options and features as seen and described in relation to the embodiment illustrated in FIG. 1, with the substitution of an existing structure (23), manmade or natural, as a replacement for the floating platform. If an existing structure (23) is already located by a viable site, it is advantageous to use it to support the generator (17) to save cost in materials and engineering work.

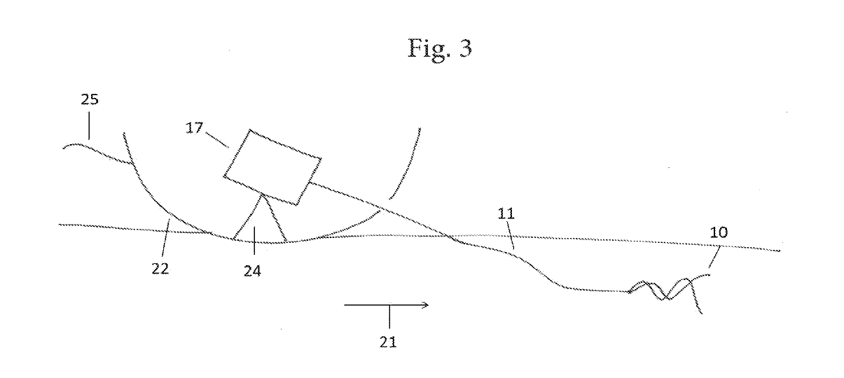

FIG. 3 is a water level view detailing an adaptation of the embodiment illustrated in FIG. 1, where the generator (17) is supported by a structure (24) that permits slight positional adjustments in the vertical axis but restricts most lateral movements (with respect to the water flow (21)), allowing the turbine (10) to establish its vertical equilibrium about the axis as water flow conditions change. Such an adaptation also more easily allows for the angle between the water surface and the power take off device to be reduced as much as possible, thereby improving the transmission of rotational movement from the turbine to the power take off device. The anchoring system (25) is depicted as a single line upstream of the machine The anchoring system (25) is intended to be flexible to further support the freedom of movement of the turbine. Such flexibility exhibited by the system is intended to improve efficiency and resiliency to debris and other harmful materials that may come in contact with the water drive turbine system.

A flexible tether connection is inherently less efficient than a fixed shaft as some of the energy will be transferred to the tether in the form of winding (tension) which may also be built up and expelled as heat. Furthermore, a turbine that is not aligned with the rotational machine is also inherently less efficient as the force of the turbine will be applied in more than one direction. From a practical stand point, such a configuration is unlikely to be possible without a self-stabilizing rotor, such as the rotor described above.

Despite these drawbacks, the water turbine drive system described above is advantageous because marine hydrokinetic energy is a promising resource that is hindered by high capital costs, limited site viability and risk from damaging debris. Using a tether member to provide the connection between the water turbine and the rotational machine allows for the machine to be located above the water, reducing capital costs. It also allows the water turbine to be deployed in shallower water which improves site viability. Further, this configuration generally prevents damage from debris as larger debris strikes can glance off the side of the turbine (pushing the turbine out of the way) and finer debris can run straight through the turbine, leading to a more resilient system. Consequently, although not theoretically ideal from an energy transfer standpoint, configuring the water turbine drive system in this manner reduces many of the downsides to marine hydrokinetic energy. As a result, the water turbine drive system allows marine hydrokinetic energy to be used where it previously was not feasible to do so.

The water turbine drive system may be adapted to drive many types of rotating machine It has special application for use in driving electrical generators. Therefore, the embodiments are described with reference to use with electrical generators. However it is to be understood that the invention is not to be limited in use only to such applications.

Those skilled in the art will recognize that many adaptations may be made to the embodiments which have been described. It is to be appreciated that all such adaptations are to be considered as being within the scope of the invention.

1. A water turbine drive system comprising a rotating machine driven by a water turbine disposed remote from the machine for generating rotational power from a flowing water stream, wherein the machine and turbine are connected together by a tether member adapted to be rotated by the turbine and transmit the rotation and thereby drive the machine wherein the tether member permits positional movement of the turbine relative to the machine such that the rotational axis of the turbine need not be co-aligned with the rotational axis of a driven rotating member of the machine.

2. The water turbine drive system of claim 1 wherein the tether member and turbine in combination facilitate the turbine's ability to establish vertical equilibrium within the water column without contacting the bottom.

3. The water turbine drive system of claim 1 wherein the tether member and turbine in combination maximizes the transmission of rotational movement from the turbine to the power take off device by reducing the angle between the water surface and the power take off device as much as possible.

4. The water turbine drive system of claim 1 wherein the turbine comprises a rotor which is configured to cause the turbine to position itself in the region of greatest water flow as a result of the water flow.

5. The water turbine drive system of claim 4 wherein the rotor is configured with an active surface which defines an arcuate fluid pathway for fluid flow about the central axis about which the rotor is able to rotate, wherein the surface has the configuration of a logarithmic curve substantially conforming to the Golden Section to thereby enable the rotor to be caused to move into the region of greatest water flow.

6. The water turbine drive system of claim 1 wherein the tether member is flexible.

7. The water turbine drive system of claim 6 wherein the material of the tether member and the material and configuration of the turbine are selected to ensure stable position of the rotor with the water flow stream.

8. The water turbine drive system of claim 1 wherein the turbine is caused to rotate by a water stream of a river.

9. The water turbine drive system of claim 1 wherein the turbine is caused to rotate by a water stream caused by tidal water flow.

10. The water turbine drive system of claim 1, wherein the turbine is caused to rotate by a water stream caused by ocean currents.

11. The water turbine drive system of claim 1 wherein the turbine is caused to rotate by a water stream caused by man-made canals, flumes or effluent systems.

12. The water turbine drive system of claim 1 wherein the machine is supported above the surface of the water by a floatation device.

13. The water turbine drive system of claim 1 wherein the machine is supported above the surface of the water on land or on a support platform.

14. The water turbine drive system of claim 1 wherein the water turbine drive system permits some movement of the machine in the vertical direction about a horizontal axis disposed substantially transversely to the water flow stream.

15. The water turbine drive system of claim 1 wherein the machine is an electrical generator.

16. The water turbine drive system of claim 1 wherein the machine is any device which can convert rotational energy into useable power.

17. A water turbine drive system comprising a tether member operatively connecting a water-driven turbine with a rotating machine to enable the tether member to transmit torque generated by the turbine to the machine to cause rotation of a rotating member of the machine, wherein the tether member is configured to permit angular displacement of the turbine rotational axis relative to the rotating member rotational axis during use.
